(19) United States
(12) Patent Application Publication
(10) Pub. No.: US 2007/0233702 A1
(43) Pub. Date: Oct. 4, 2007

(54) Device and method for retrieval in network

(75) Inventors: Hideki Ohkita, Kunitachi-shi (JP); Shigeru Maeda, Tachikawa-shi (JP); Kazunobu Konda, Tokyo (JP); Ken Matsushita, Tama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/729,875

(22) Filed: Mar. 30, 2007

(30) Foreign Application Priority Data
Mar. 31, 2006 (JP) 2006-101117

(51) Int. Cl. G06F 17/30

(52) U.S. Cl. 707/10

(57) ABSTRACT

A device discovery section discovers devices connected to a network. A metadata acquisition section acquires, via a communication section, all summary information held by the detected devices and containing recording dates and times of image contents. The metadata acquisition section stores the summary information acquired in a metadata control section. A detailed information acquisition section selects some of the image contents stored in the metadata control section on the basis of the recording dates and times of the image contents. The detailed information acquisition section selects some of the plurality of image contents for which the summary information acquisition section has acquired the summary information, on the basis of the recording dates and times in the summary information A display item control section arranges the detailed information acquired by the detailed information acquisition section in date cells on a display screen to display the information on the display screen.

### CROSS-REFERENCE TO RELATED APPLICATIONS

This application is based upon and claims the benefit of priority from Japanese Patent Application No. 2006-101117, filed Mar. 31, 2006, the entire contents of which are incorporated herein by reference.

### BACKGROUND

1. Field

The present invention relates to a device and method for retrieval in a network which allows the display of image contents held communication apparatuses connected together via a communication network.

2. Description of the Related Art

In recent years, recording and reproducing apparatuses have started to prevail which record a large number of contents in a recording medium such as HDD and which during reproduction of the contents, displays thumbnails of the recorded contents (representative reduced images of the contents) and detailed information on the contents such as EPG (Electronic Program Guide) information to facilitate selection of contents.

To display image contents, for example, a video image recording and reproducing apparatus disclosed in Jpn. Pat. Appln. KOKAI Publication No. 2004-297649 displays a list of the recorded image contents using a calendar screen. According to this document, image contents for which the date is important are recorded in HDD so that during reproduction, any contents can be selected and reproduced via the calendar screen.

However, Jpn. Pat. Appln. KOKAI Publication No. 2004-297649 gives no consideration to the display of a list of image contents recorded in a plurality of communication apparatuses connected to a communication network.

A relatively large memory capacity and a long transfer time are required to receive the detailed information such as thumbnails from a plurality of communication apparatuses each holding a large number of contents, via the network. This significantly degrades the operability of the apparatus reproducing the contents.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view depicting a configuration example of a system to which the invention is applied;

FIG. 2 is an exemplary view depicting an example of a metadata list;

FIG. 3 is an exemplary block diagram depicting an embodiment of a network content display device 10 in the invention;

FIG. 4 is an exemplary view depicting a relationship between metadata stored in a metadata management unit 17 and items displayed on a retrieval result screen;

FIG. 5 is an exemplary view depicting a first embodiment of a content list display screed by the network content display device 10 of the invention;

FIG. 6 is an exemplary view depicting a second embodiment of the content list display screen by the network content display device 10 of the invention;

FIG. 7 is an exemplary view depicting a third embodiment of the content list display screen by the network content display device 10 of the invention;

FIG. 8 is an exemplary view depicting a fourth embodiment of the content list display screen by the network content display device 10 of the invention;

FIG. 9 is an exemplary view depicting a fifth embodiment of the content list display screen by the network content display device 10 of the invention;

FIG. 10 is an exemplary view depicting a sixth embodiment of the content list display screen by the network content display device 10 of the invention;

FIG. 11 is an exemplary flowchart depicting a basic operation of the network content display device 10 of the invention;

FIG. 12 is an exemplary flowchart to create a display screen in FIG. 5;

FIG. 13 is an exemplary flowchart to create a display screen in FIG. 6;

FIG. 14 is an exemplary flowchart to create a display screen in FIG. 7;

FIG. 15 is an exemplary flowchart to create a display screen in FIG. 8;

FIG. 16 is an exemplary flowchart to create a display screen in FIG. 9; and

FIG. 17 is an exemplary flowchart to create a display screen in FIG. 10.

### DETAILED DESCRIPTION

Various embodiments according to the invention will be described hereinafter with reference to the accompanying drawings. In general, according to one embodiment of the invention, there is provided a network retrieval apparatus comprising a communication section which communicates with a plurality of communication apparatuses each having image contents, via a network, a detection section which detects the communication apparatuses connected to the network, a summary information acquisition section which acquires summary information held by each of the communication apparatuses detected by the detection section, the summary information containing recording dates and times for the image contents, a detailed information acquisition section which selects some of the plurality of image contents for which the summary information acquisition section has acquired the summary information, on the basis of the recording dates and times in the summary information, to acquire detailed information on the image contents via the communication section, and a display control section which allows a display device to display a display screen on which the detailed information acquired by the detailed information acquisition section is arranged.

The present invention enables the high-speed display of a list of image contents recorded in a plurality of communication apparatuses connected to a communication network.

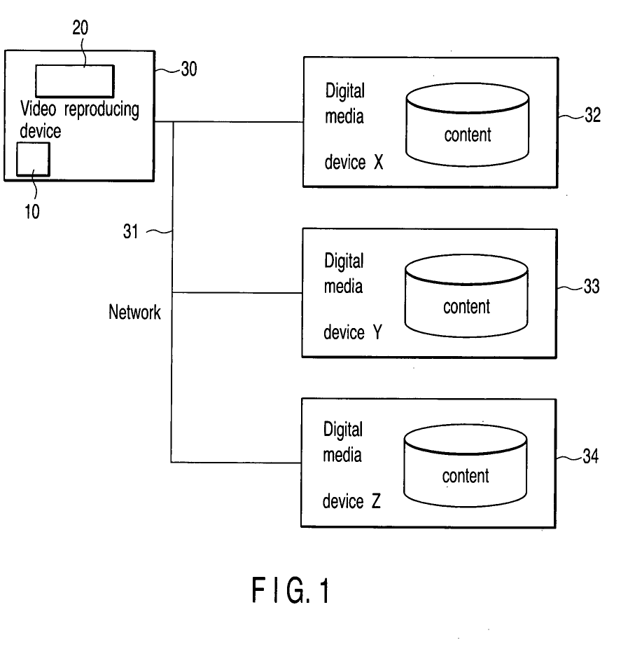

FIG. 1 is a diagram showing an example of configuration of a system to which the present invention is applied. An image reproducing apparatus 30 comprising a network retrieval device 10 in accordance with an embodiment of the present invention is connected to a plurality of digital media devices (hereinafter referred to as devices) 32 to 34 via a communication network 31.

The video reproducing apparatus 30 is, for example, a digital TV that receives and reproduces digital broadcasting. Each of the devices is, for example, a video recording and reproducing device or a video reproducing device such as a DVD recorder, personal computer, or a digital camera. The devices can communicate with the video reproducing apparatus 30 via the network 31. The network 31 is a home network such as LAN (Local Area Network) which is placed in general homes.

The network retrieval device 10, provided in the video reproducing apparatus 30, accesses the devices 32 to 34 via the network to acquire metadata accompanying the image contents held by each data to create a list of the metadata.

Here, the metadata is summary information on the contents such as the titles and recording dates and times of the contents which allows the contents to be identified and sorted.

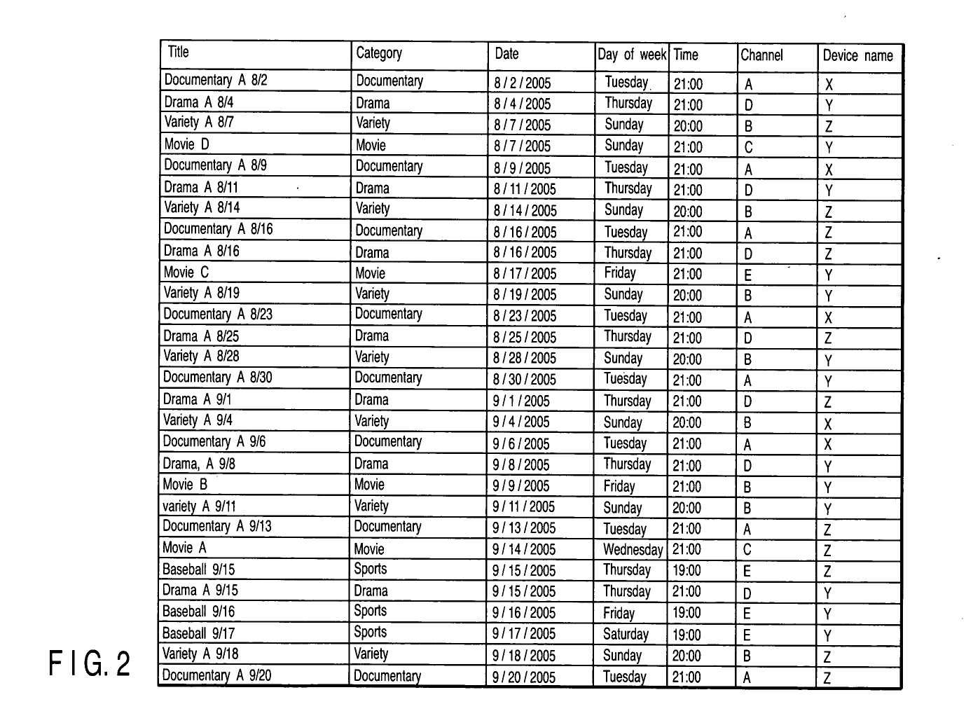

FIG. 2 shows an example of a list of metadata. In the example in FIG. 2, the metadata contains the tiles, genres, recording dates and times, and days of the week of the contents and the channels and devices for the contents. In the illustrated example, a metadata control section 17 controls the metadata in three devices X, Y, and Z as one table.

The network retrieval device 10 can thus uniformly handle the contents regardless of their locations (devices) by controlling the metadata held by the plurality of device on the basis of the table. Users can manipulate the contents without regard to the locations of the contents.

Exemplary types of contents include not only video programs such as those shown in FIG. 2 but also still images and motion pictures taken with a digital camera or a video camera.

The network retrieval device 10 creates a list of the contents on the basis of the list of the metadata. The video reproducing apparatus 30 displays the created list of the contents on a display section 20. The video reproducing apparatus 30 also acquires video data on a content selected by the user on the basis of the list of the contents, via the network 31. The video reproducing apparatus 30 then reproduces and displays the video data acquired on the display section 20.

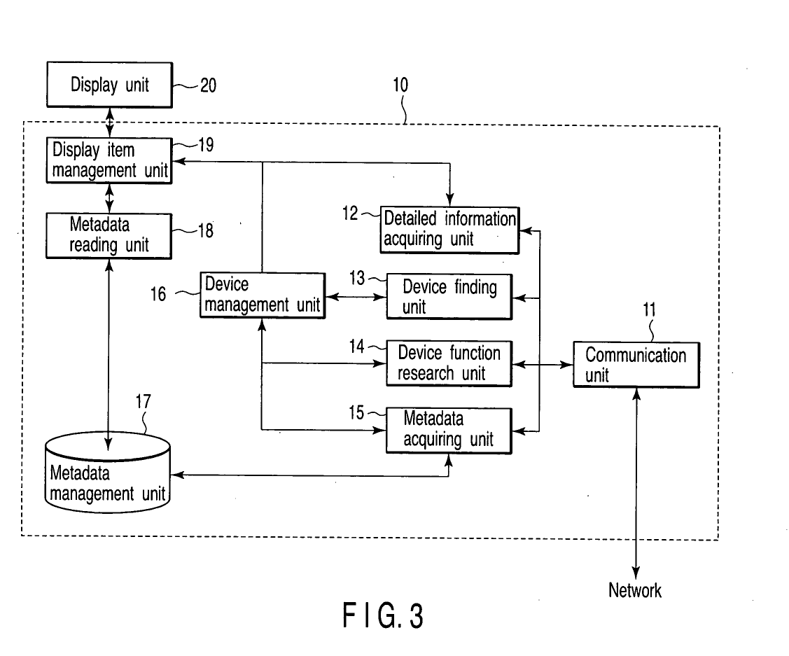

FIG. 3 is a block diagram showing the network retrieval device 10 in accordance with the present embodiment.

A device discovery section 13 discovers, via a communication section 11, a device being powered on the network 31 and communicates the discovery to a device control section 16. Further, when the contents held by any of the devices are updated, the device discovery section 13 detects and communicates this to the device control section 16.

The device control section 16 gives instructions to a device function check section 14, which checks the function of the discovered device via the communication section 11. Here, the function of the device is assumed to be a contents retrieval function, specifically, a function for supporting retrieval commands such as Browse and Search which are described in the UPnP (Universal Plug and Play) specifications.

The device control section 16 acquires the metadata on the contents held by the device, via a metadata acquisition section 15 on the basis of the check executed by the device function check section 14. The device control section 16 then stores the metadata in a metadata control section 17. Once the acquisition of the metadata is completed, the device control section 16 notifies a display item control section 19 of completion of acquisition of the metadata.

The display item control section 19 acquires metadata required for display via a metadata reading section 18. In this case, if the metadata acquired lacks required information, the display item control section 16 acquires the required information from the device via detailed information acquisition section 12. The display item control section 19 displays the metadata and detailed information on the display section 20.

The metadata is also required for retrieval and sorting of display items and for a display position for detailed information on the contents in the content list. Since the display item control section 19 determines the display orders and positions of the contents on the basis of the metadata, during metadata acquisition, the metadata acquisition section 15 in the network retrieval device 10 needs to acquire the metadata on all the contents from each device.

On the other hand, the detailed information is required when the display item control section 19 actually lays out and displays the list of the contents on the screen of the display section 20 or the like. The detailed information acquisition section 12 needs to acquire only a part of the detailed information on all the metadata stored in the metadata control section 17 which relates to the contents to be actually displayed on the display.

Examples of the detailed information handled by the detailed information acquisition section 12 include thumbnails (reduced images) of the contents and descriptions of the contents acquired from EPG. The metadata and detailed information shown in the present embodiment are illustrative. Depending on the specification of the application, for example descriptions of programs may be used as metadata, or in contrast, information such as dates and times may be used as detailed information. In the description of the present embodiment, thumbnails are used as the detailed information.

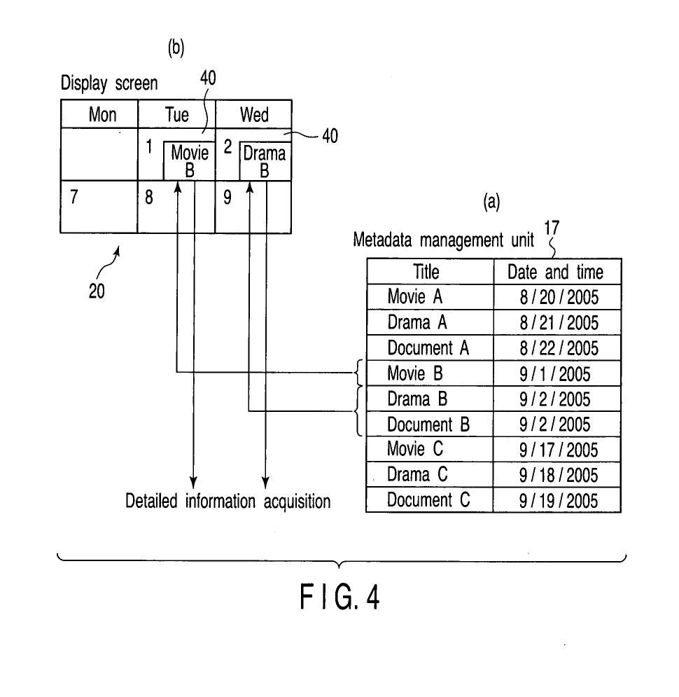

FIG. 4 is a diagram showing the relationship between the metadata stored in the metadata control section 17 and items displayed on a retrieval result screen (content list). The content list can be displayed in various forms; the list may be displayed in calendar form as shown in FIG. 4 or simply in order by date or in order by date for each device. In the present embodiment, it is assumed that the user selects the display in calendar form.

The metadata control section 17 stores, as retrieval results, metadata such as the titles and recording dates and times of contents recorded as shown in FIG. 4(a).

To display the retrieval results on the display section 20 in calendar form as shown in FIG. 4(b), the display item control section 19, the display item control section 19 first acquires metadata corresponding to date cells (rectangular display areas) 40 from the metadata control section 17. Here, metadata (titles and dates) on a movie B recorded on September 1 and a drama B and a documentary B recorded on September 2.

The display item control section 19 subsequently acquires detailed information from the corresponding device on the network via the detailed information acquisition section 12.

In FIG. 4, to display thumbnails of the movie B and drama B on the calendar screen, the display item control section 19 acquires thumbnail information on these contents from the corresponding device.

The metadata control section 17 holds metadata such as titles and dates which is required to select or sort contents, for all the contents in all the powered-on devices. On the other hand, for information with a larger amount of data such as thumbnails which is required only for display on the display section, the metadata control section 17 acquires such information only for contents to be displayed on the display section 20 after the arrangement of the contents has been determined.

This enables the retrieval results to be displayed at high speed while reducing the memory utilization in the network retrieval device 10.

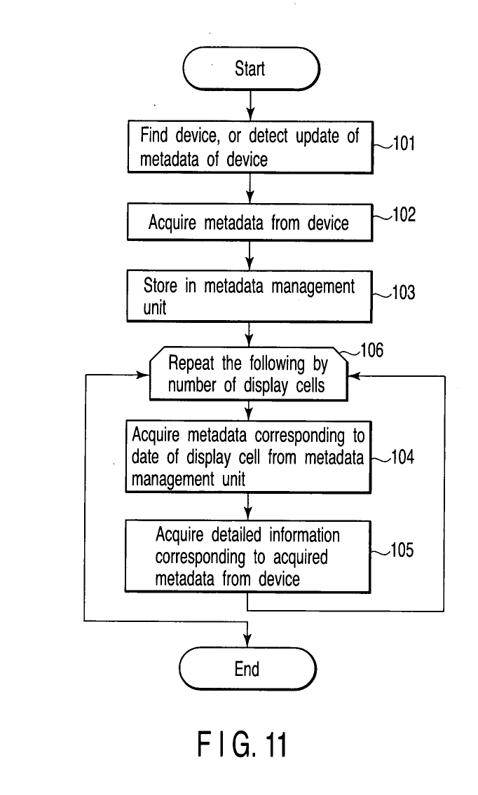

FIG. 11 is a flowchart showing all of the above operations of the network retrieval device 10.

In FIG. 11, at first when the device finding unit 13 finds the devices or detects the update of the metadata of the devices (block 101), the metadata acquiring unit 15 acquires the metadata from the concerned devices (block 102). The device management unit 16 stores the acquired metadata in the metadata management unit 17 (block 103). Thus, the all items of the latest metadata of the devices with power applied thereto are stored in the metadata management unit 17.

The item management unit 19 acquires the metadata corresponding to the dates of the display cells at which the displays are instructed from the metadata management unit 17 (block 104). The detailed information acquiring unit 12 acquires the detailed information corresponding to the acquired metadata from the corresponding devices (block 105). The item management unit 19 repeats the processes in blocks 104-105 by the number of display cells (block 106).

As described above, the present embodiment has means for allowing the metadata acquisition section 15 to acquire metadata required to retrieve or sort contents and allowing the metadata control section 17 to control the metadata, and means for acquiring detailed information not contained in the metadata control section 17 from the detailed information acquisition section 12 if metadata needs to be actually displayed. This enables the contents to be sorted or listed at high speed while minimizing the amount of memory required to control metadata.

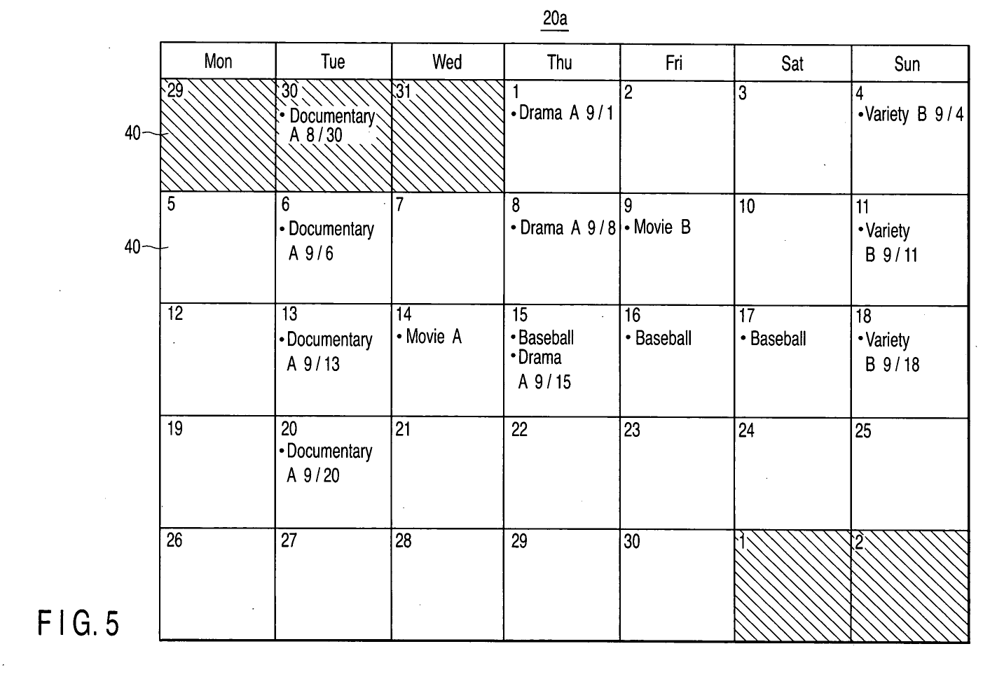

FIG. 5 is a diagram showing a first embodiment of a content list display screen provided by the network retrieval device 10 in accordance with the present invention.

FIG. 5 shows an example in which the network retrieval device 10 displays contents metadata on the calendar. The display item control section 19 displays each area on the calendar as a display date cell 40. The display item control section 19 acquires metadata on the contents corresponding to each date cell 40 from the metadata control section 17 via the metadata reading section 18 and places the metadata in the data cell 40.

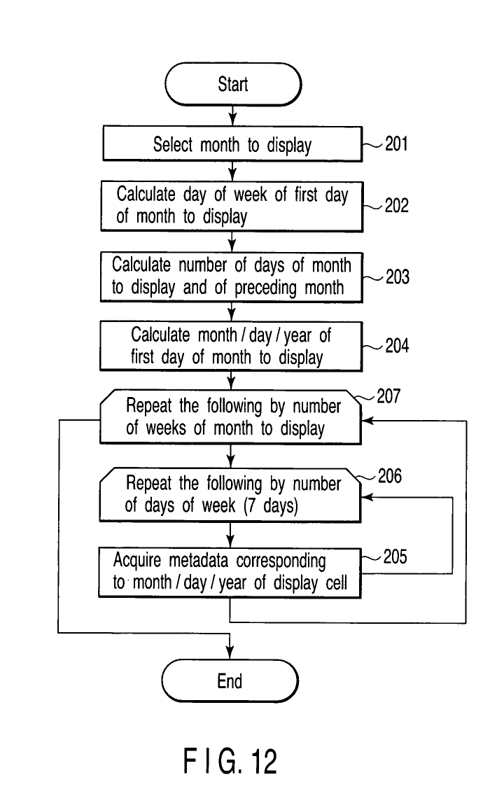

FIG. 12 is a flowchart showing how to create a display screen.

In FIG. 12, the display item managing unit 19 selects the month to display in response to the user's instruction (block 201), calculates the day of the week for the first day of the month to display (block 202), calculates the number of days of the month to display and of its preceding month (block 203), and calculates the month, day and year of the first of the month to display (block 204).

Next to this, the display item management unit 19 acquires the metadata corresponding to the month, day and year of the display cell (block 205), and repeats the acquiring process of the number of days (seven days) in the week (block 206). Further, the item management unit 19 repeats the processes in blocks 205 and 206 by the number of weeks of the month to display (block 207).

Thus, displaying only the contents metadata on the calendar screen enables higher-speed display and is effective in, for example, consecutively switching the calendar screen to search for recorded contents.

Each date cell may display the device name of the device holding the corresponding content. This enables the easy determination of which device holds any particular content.

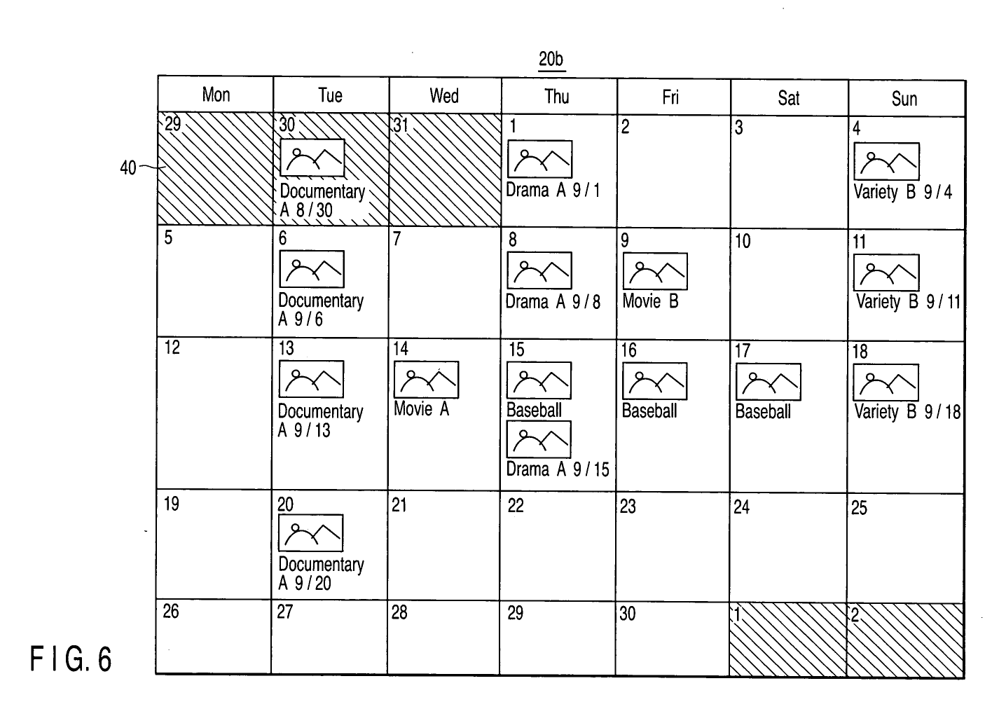

FIG. 6 is a diagram showing a second embodiment of a content list display screen provided by the network retrieval device 10 in accordance with the present invention.

FIG. 6 shows an example in which a thumbnail of each content is displayed in addition to its metadata. This display can be provided by allowing the display item control section 19 to acquire metadata on the contents corresponding to the respective date cells and then allowing the detailed information acquisition section 12 to acquire only thumbnail information accompanying each of these contents from the corresponding device.

In the example in FIG. 6, if each display cell 41 contains a large number of metadata and pieces of detailed information, the size of the display cell is increased in response to the user's instruction (including selection of contents) so as to appropriately display a large number of contents.

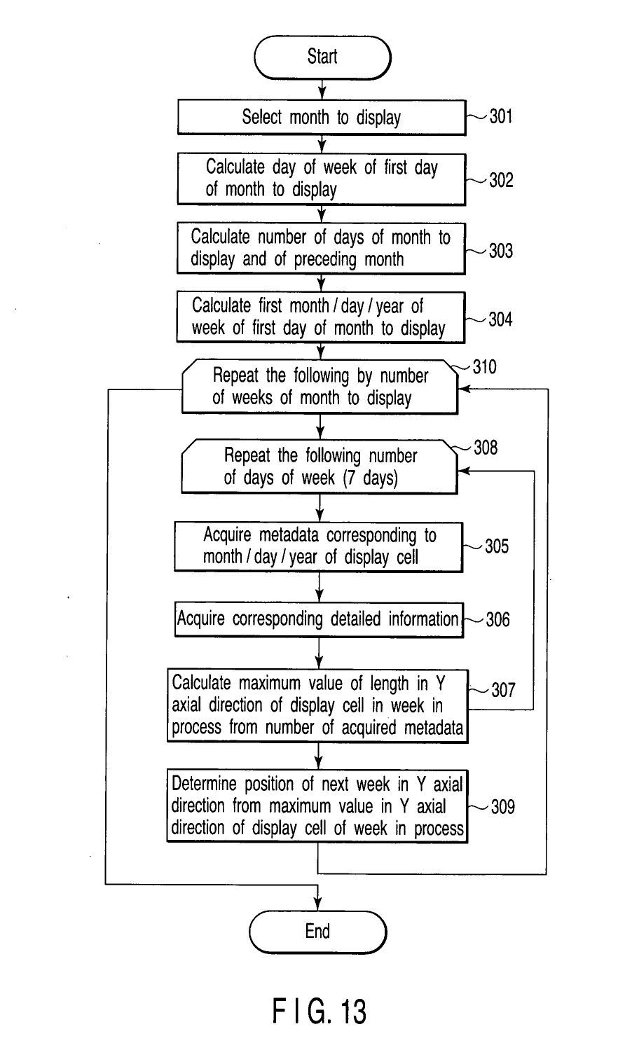

FIG. 13 is a flowchart showing how to create this display screen.

In FIG. 13, the item management unit 19 selects the month to display (block 301), calculates the day of the week of the first day of the month to display (block 302), calculates the number of days of the month to display and of its preceding month (block 303), and calculates the month, day and year of the first day of the month to display (block 304).

Next, the item management unit 19 acquires the metadata corresponding to the month, day and year of the display cell from the corresponding device (block 305), and acquires the corresponding detailed information (thumbnail) from the concerned devices (block 306). The item managing unit 19 calculates a maximum value of a length in a Y axial direction (longitudinal direction) of the display cells in the week in processing from the number of pieces of the acquired meta data (block 307). The item managing unit 19 repeats the processes in blocks 305-307 of the number of days in the week (seven days) (block 308), and determines the positions of the next week in the Y axial direction from the maximum value in the Y axial direction of the display cells in the week in processing (block 309). Further, the item management unit 19 repeats the processes in blocks 305-309 by the number of weeks of the month to display (block 310).

Thus displaying thumbnails in addition to metadata enables each content to be checked in detail.

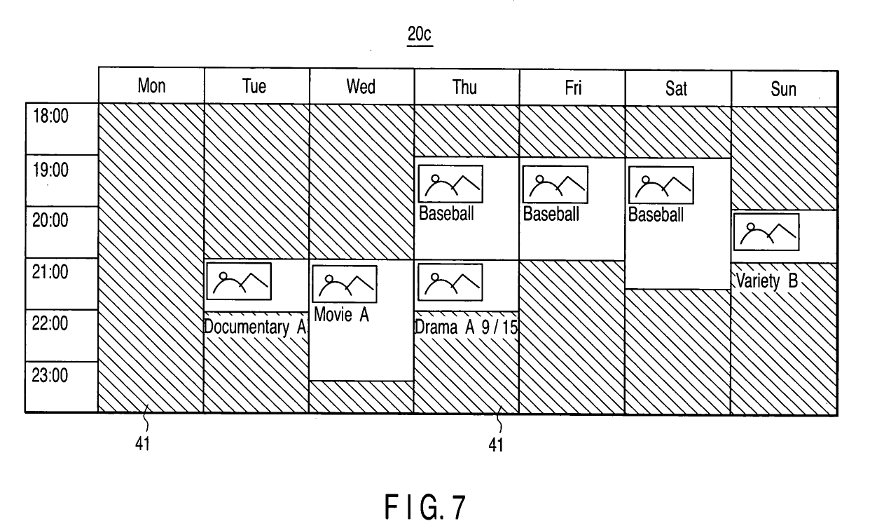

FIG. 7 is a diagram showing a third embodiment of a content list display provided by the network retrieval device 10 in accordance with the present invention.

In this case, each of the display cells 41 handled by the display item control section 19 constitutes a predetermined time unit. For example, a display area for 18:00 to 24:00 on Thursday corresponds to one display cell 41, with two contents, “Baseball” and “Drama 9/15”, displayed in the display cell 41.

Moreover, the display item control section 19 determines the positions of “Baseball” and “Drama 9/15” on the display cell 41 depending on the periods when the respective contents were recorded. In the example in FIG. 7, “Baseball” is located at a position corresponding to 19:00 to 21:00, and “Drama 9/15” is located at a position corresponding to 21:00 to 22:00.

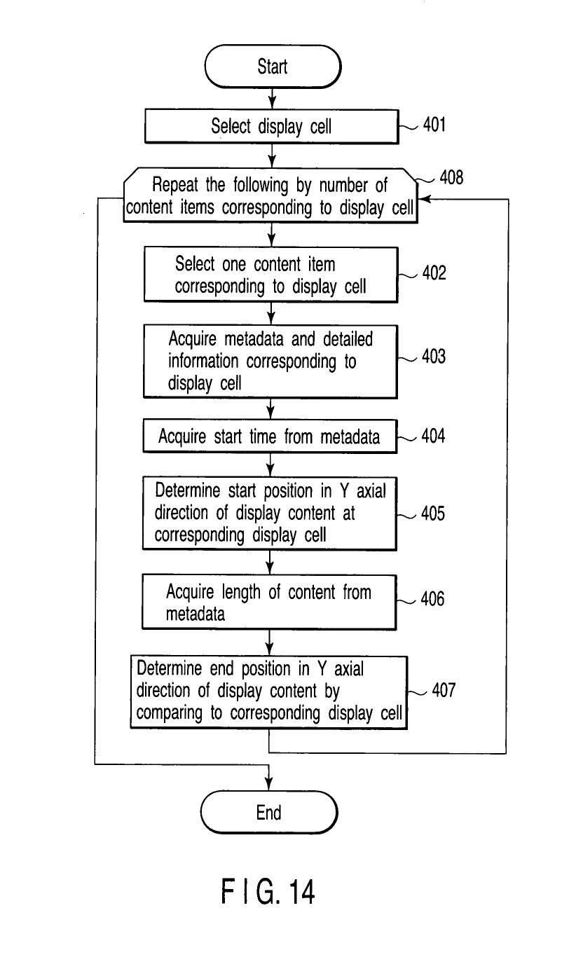

FIG. 14 is a flowchart showing how to create the display screen in FIG. 7.

In FIG. 14, the display item management unit 19 selects a display cell (block 401), selects one content corresponding to the display cell (block 402), and acquires the metadata and the detailed information corresponding to the display cell (block 403). The item management unit 19 obtains the start time form the metadata (block 404), and determines the start position in the Y axial direction of the display content (metadata and detailed information) in the corresponding display cell 41. The management unit 19 obtains the length (reproduction time) of the content from the metadata (block 406), and compares the length with the length of the corresponding display cell 41 to determine the end position in the Y axial direction of the display content (block 407). The management unit 19 repeats the processes in blocks 402-407 of the number of contents corresponding to the display cell (block 408).

This display method enables the content list to be displayed as shown in FIGS. 5 or 6. Further, if each display cell 41 contains a large number of metadata and pieces of detailed information, the size of the display cell can be increased in response to the user's instruction (including selection of contents) so as to appropriately display a large number of contents. Moreover, the time zone in which each content was recorded (broadcast) can be visually determined.

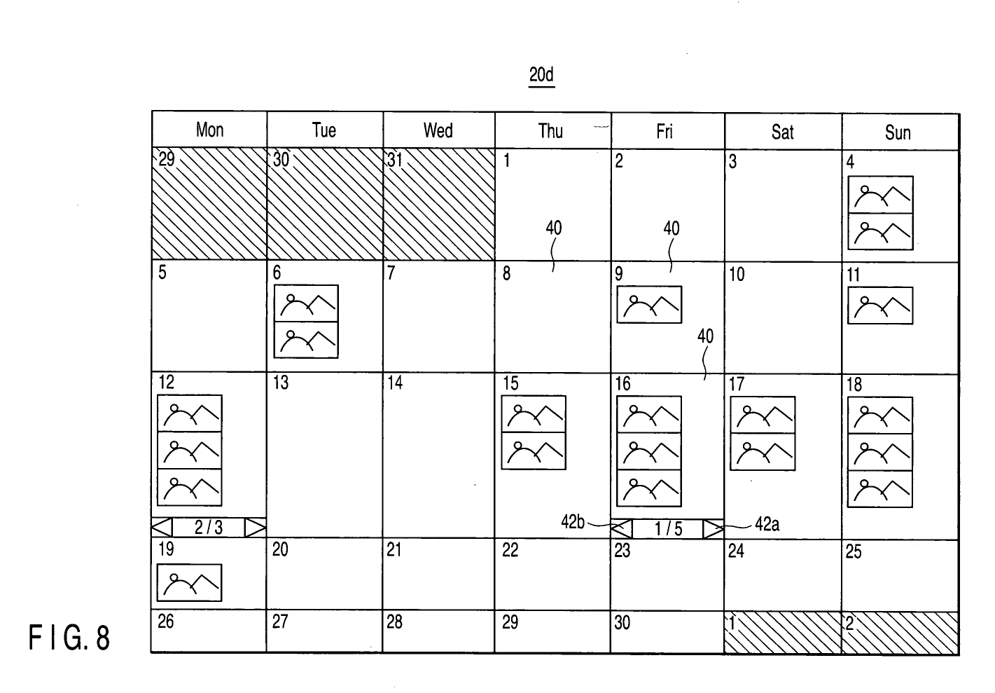

FIG. 8 is a diagram showing a fourth embodiment of a content list display provided by the network retrieval device 10 in accordance with the present invention.

In this case, only the thumbnails of the contents are selected as items to be displayed on the display screen. The basic process in accordance with the fourth embodiment is the same as that for the display in FIG. 6 except that the display item control section 19 automatically varies the size of the date cells in each week depending on the number of contents to be displayed. If any date cell has too many contents to contain in the single cell, the display item control section 19 divides the contents into a plurality of pages and provides a page turning button 42.

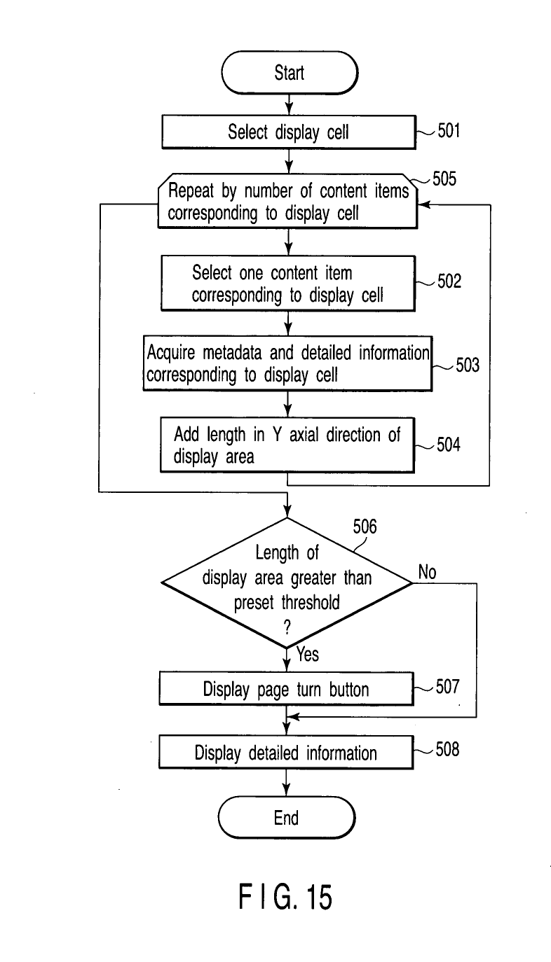

For example, the date cell 40 for 16th comprises five pages, with its first page displayed. When the user selects a button 42a, the next page is displayed. Selecting a button 42b displays the preceding page. FIG. 15 is a flowchart showing how to create this display screen.

In FIG. 15, the item management unit 19 selects a display cell (block 501), selects one content corresponding to the selected display cell (block 502), acquires the metadata and the detailed information corresponding to the display cell (block 503), and adds a length in a Y axial direction of a display area (block 504). The item management unit 19 repeats the processes in blocks 502-504 of the number of contents corresponding to the display cell (block 505).

Further, the item management unit 19 determines whether the length of the display area is longer than the preset threshold (block 506), if longer, it displays page turning buttons 42a and 42b (block 507) to display the detailed information (block 508). If the length of the display area is shorter than the preset threshold in block 506 (if “No”), the flow shifts to block 508 to display the detailed information (block 508).

Even if any date cell contains a large number of contents, the display method in accordance with the fourth embodiment enables the contents to be displayed.

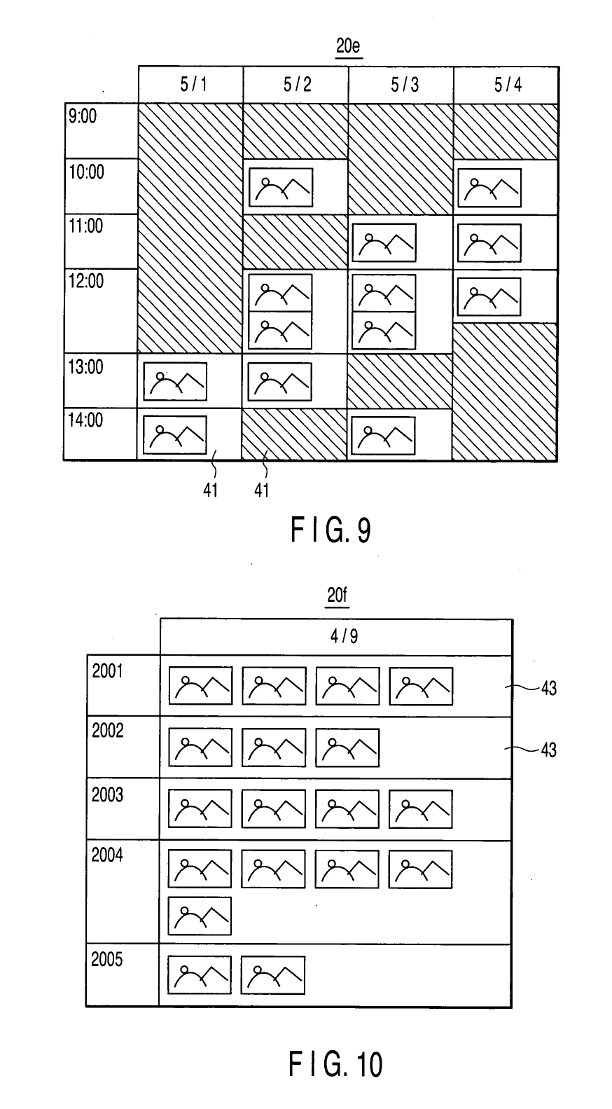

FIG. 9 is a diagram showing a fifth embodiment of a content list display provided by the network retrieval device 10 in accordance with the present invention.

With the content list displayed for each month as shown in FIGS. 5 or 6, when the user selects one of the date cells, the display item control section 19 compares the number of the contents in the date cell with a predetermined threshold A (the threshold includes 1). If the number of consecutive display cells including the selected date cell and each containing at least a predetermined threshold number A of contents is at least a predetermined threshold B (the number of days), the display item control section 19 switches to the display screen to one such as shown in FIG. 9. The display item control section 19 displays the series of display cells so that they correspond to the respective hours.

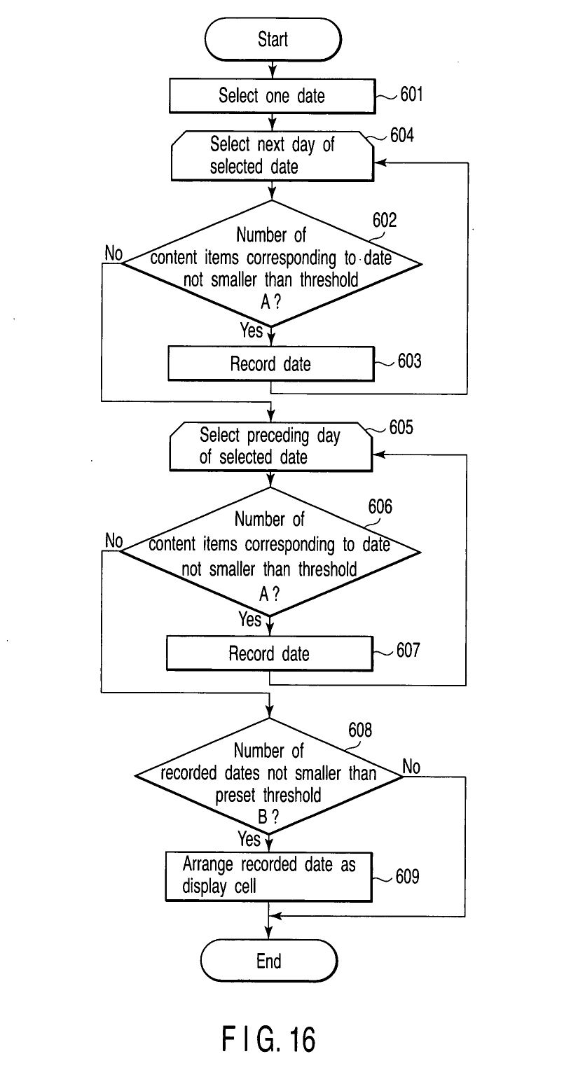

FIG. 16 is a flowchart showing how to create this display screen.

The item management unit 19 selects one date in response to the user's instruction (block 601), and determines whether or not the number of contents corresponding to the date are present not less than threshold A (block 602). If the number is equal to threshold A or larger, the item management unit 19 records the date (block 603), selects the date next to the selected date (block 604) then executes the process of block 602. The item management unit 19 repeats the processes of blocks 602-604 until it is determined as “No” in block 602.

If the number of contents corresponding to the selected date is smaller than threshold A (No, in block 602), the item management unit 19 selects the date of the preceding day of the date firstly selected in block 601 (block 605) to determine whether the number of contents corresponding to the date is equal to or over threshold A (block 606). If the number is equal to or over threshold A, the item management unit 19 records the date (block 607). Then, the item management unit 19 selects the date of the preceding day of the data currently selected (block 605) to execute the process of block 606. Until it is determined as “No” in block 606, the item management unit 19 repeats the processes of blocks 605-607.

If the number of contents corresponding to the selected date is smaller than threshold A (No, in block 606), the item management unit 19 determines whether the number of dates recorded in blocks 603 and 607 are prescribed threshold B or larger (block 608). If the number of dates is equal to or larger than threshold B, the item management unit 19 arranges the cells corresponding to the recorded dates as display cells. If the recorded number is not larger than prescribed threshold B (No, in block 608), the flow comes to end.

This display method is applied to a list display of, for example, still images or motion pictures taken with a digital camera during an overnight trip. The display item control section 19 automatically selects and displays display cells with consecutive dates. This enables a list of trip photographs to be displayed by the user's easy operation.

Conditions for switching to the display in FIG. 9 may include the fact that the device is a camera in addition to the number of contents equal to or greater than the threshold A and the number of consecutive days equal to or greater than the threshold B.

FIG. 10 is a diagram showing a sixth embodiment of a content list display provided by the network retrieval device 10 in accordance with the present invention.

With a content list for a certain year displayed for each month as shown in FIGS. 5 or 6, when the user selects one of the date cells, the display item control section 19 compares the number of the contents (still images or motion pictures) in the date cell which were photographed with, for example, a digital camera, with a predetermined threshold B (the threshold includes 1).

If the date cell selected by the user contains at least a predetermined threshold A number of contents, the display item control section 19 determines whether or not a predetermined threshold A number of contents photographed with the digital camera on the same day of the year have been present for a threshold B number of consecutive years including that year (the number of years).

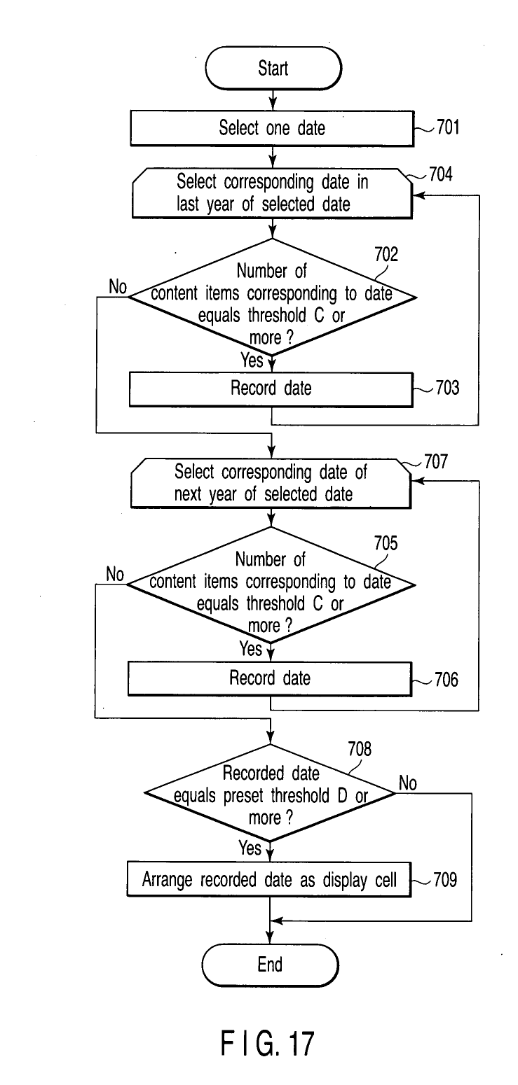

If a threshold A number of contents are present for each year, the display item control section 19 switches the display in FIGS. 5 or 6 to the one in FIG. 10 to display a list of date cells 43 for each year. FIG. 17 is a flowchart showing how to create this display screen.

In FIG. 17, the item management unit 19 selects one date in response to the user's instruction (block 701) to determine whether the number of contents corresponding to the selected date is equal to or larger than threshold C (block 702). In the case of being not smaller than threshold C, the item management unit 19 records the date (block 703). The item management unit 19 then selects the corresponding date in the last year from the selected date (block 704) to execute the process in block 702. Until it is determined as “No” in block 702, the item management unit 19 repeats the processes of block 702-704.

If the contents corresponding to the selected date is not present in the number of threshold C or more (No, in block 702), the item management unit 19 selects the corresponding date in the years later than the selected date (block 704), and determines whether the number of contents equal to or more than threshold C are present or not (block 705). If the number is not smaller than threshold C, the item management unit 19 records the date (block 706). The item management unit 19 then selects the corresponding dates later than the years of the selected date in turn to repeat the processes in blocks 705 and 706 (block 605).

If the number of contents corresponding to the selected date is not more than threshold C (No, in block 705), it is determined whether the recorded date is not smaller than prescribed threshold D (block 707), if it is not smaller than threshold D, the recorded date is disposed as the display cell (block 708). If the recorded date is smaller than threshold D (No, in block 707), the flow ends.

Applications of this display method include the display of course of a yearly event, for example, the birthday or wedding anniversary. Since the display item control section 19 automatically selects a yearly event, the user can display a list for such an event through an easy operation to easily reproduce and display contents such as a record of growth of the user's child.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A network retrieval device comprising:
a communication section which communicates with a plurality of communication apparatuses via a network, each of the plurality of communication apparatuses having image content;
a detection section which detects the communication apparatuses connected to the network;
a summary information acquisition section which acquires summary information from each of the communication apparatuses via the communication section, the summary information containing recording dates and times of the image contents held by the communication apparatus detected by the detection section;
detailed information acquisition section which selects some of the plurality of image contents for which the summary information acquisition section has acquired the summary information, on the basis of the recording dates and times in the summary information; and
a display control section which allows a display device to display a display screen in which the detailed information acquired by the detailed information acquisition section has acquired.

2. The network retrieval device according to claim 1, wherein the display control section displays, on the display screen, display areas in which detailed information on image contents is arranged, and then displays, on the display screen, the detailed information acquired by the detailed information acquisition section has acquired.

3. The network retrieval device according to claim 1, wherein the detailed information acquired by the detailed information acquisition section contains image data.

4. The network retrieval device according to claim 2, wherein the display screen displayed under the control of the display control section displays the detailed information on the image contents in a plurality of display areas in the order of the recording date and time.

5. The network retrieval device according to claim 3, wherein the display screen displayed under the control of the display control section displays the detailed information on the image contents in a plurality of display areas in the order of the recording date and time.

6. The network retrieval device according to claim 1, further comprising a check section which checks a content retrieval function of each of the communication apparatuses detected by the detection section;
wherein the summary information acquisition section uses a command corresponding to the content retrieval function checked by the check section to acquire the summary information on the image contents held by the communication apparatus.

7. The network retrieval device according to claim 1, wherein the detection section detects update of the summary information on the contents held by each of the communication apparatuses on the network, and
the summary information acquisition section acquires the updated summary information.

8. A method for retrieval in a network, the method being used in a system comprising a plurality of communication apparatuses each having image contents are connected to a retrieval device via the network, the method being executed by the retrieval device, the method comprising:
detecting the communication apparatuses connected to the network;
acquiring summary information on the image contents from the detected communication apparatus via the network;
selecting some of the plurality of contents for which the summary information has been acquired, on the basis of recording dates and times in the summary information, and acquiring detailed information on the selected image contents via the network; and
arranging the acquired detailed information in a display screen and controlling a display device to display the display screen.

9. The method for retrieval in a network according to claim 8, wherein the controlling the display section to display detailed information includes displaying, on the display screen, display areas in which detailed information on image contents is arranged and then displaying the detailed information acquired on the display screen.

10. The method for retrieval in a network according to claim 8, wherein the detailed information contains image data.

11. The method for retrieval in a network according to claim 8, wherein the display screen displays the detailed information on the image contents in a plurality of display areas in the order of the recording date and time.

12. The method for retrieval in a network according to claim 9, wherein the display screen displays the detailed information on the image contents in a plurality of display areas in the order of the recording date and time.

13. The method for retrieval in a network according to claim 8, wherein the acquiring the summary information includes checking a content retrieval function of each of the detected communication apparatuses and requesting the summary information containing the recording dates and times of the image contents on the image contents held by the communication apparatus by mean of a command corresponding to the content retrieval function of the apparatus.

14. The method for retrieval in a network according to claim 8, wherein the detecting the communication apparatuses includes detecting update of the summary information on the contents held by each of the communication apparatuses on the network, and the acquisition includes acquiring the updated summary information.
